(19) United States
(12) Patent Application Publication
(10) Pub. No.: US 2008/0127328 A1
(43) Pub. Date: May 29, 2008

(54) Peripheral and method for securing a peripheral and operating same

(75) Inventors: Leonardo William Estevez, Rowlett, TX (US); Richard D. Wietfeldt, Richardson, TX (US); Hung Vuong, Frisco, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/605,732

(22) Filed: Nov. 28, 2006

(51) Int. Cl. G06F 21/04; G06F 3/00

(52) U.S. Cl. 726/17; 710/8

(57) ABSTRACT

A peripheral and a method for securing and operating the peripheral. A preferred embodiment comprises scanning a communications media for identifiers of devices utilizing the communications media, selecting identifiers from the scanned identifiers, applying a logical combination function to the selected identifiers, and securing the peripheral based on an output of the applying. The securing of the peripheral can be totally transparent to a device coupled to the peripheral, as is the granting of access to the peripheral. No changes to the device or to software in the device are needed, which can simplify development and implementation of the present invention. Furthermore, without requiring changes to the devices to which the peripherals are attached, the cost of the implementation can be kept to a minimum, while not affecting the reliability of the devices.

### TECHNICAL FIELD

The present invention relates generally to a peripheral and a method for securing peripherals of electronic devices, and more particularly to a peripheral and a method for seamlessly and actively securing and operating the peripheral.

### BACKGROUND

Preventing unauthorized access to electronic devices and their peripherals has become a major concern for governments, businesses, and individuals. Data storage devices, communications subsystems (modems, network adapters, and so on), data capture devices (cameras, scanners, sound recorders, and so forth), data display devices (monitors, multi-media displays, audio speakers, etc.), and so forth, that can be attached to electronic devices can be susceptible to theft since they tend to be small and can be difficult to physically secure. For example, data storage devices, such as portable hard drives, USB memory devices, and so forth, can easily be stolen due to their portability and size. If stolen, any unsecured information stored on the mass storage devices can be readily accessed. Short of physically fixing the peripherals in place, it can be hard to secure the peripherals. Rather than permanently attaching the peripherals to the electronic devices to prevent their theft, techniques to prevent unauthorized access to the peripherals after they have been stolen have been developed. These techniques can also be used to control user access.

A prior art technique that has been used to prevent unauthorized access involves the user entering some form of authentication information. Once the authentication information has been entered and verified as being valid, access to secured portions or functions of the peripheral can be granted. Examples of authentication information can include user login and passwords, pass phrases, pass sequences, biometric information, and so on.

With reference now to FIG. 1, there is shown a diagram illustrating a prior art technique for securing a peripheral, wherein authentication information is used to grant or deny access. When a user wants access to a peripheral, the user can attempt to make use of the peripheral. For example, if the peripheral is a mass storage device, the user can attempt to retrieve the contents of a file in the mass storage device or write data to the mass storage device, while if the peripheral is a network adapter, the user can attempt to establish a connection in the network via the network adapter. In response to the access attempt, the electronic device to which the peripheral is connected can prompt the user to input authentication information (block 105). Examples of the authentication information can be a login/password, a pass phrase, a pass sequence, biometric information, such as a retina scan, a voice capture, or a fingerprint, and so on. The authentication information can then be checked to determine its validity (block 110). If the authentication information is valid, then the user can be granted access to the peripheral (block 115). If the authentication information is not valid, then the user can be prompted to re-enter the authentication information. The user can be permitted to re-enter the authentication information a specified number of times and if the authentication information has not been validated after the specified number of attempts, the user can be blocked from further attempts at access (not shown).

Another prior art technique that has been used to specifically secure data on mass storage devices involves the encryption of the data. Users can either manually or automatically secure files and folders. In order to access the secured files, the users will typically have to enter authentication information.

One disadvantage of the prior art techniques is that the use of authentication information to control access is a passive form of authentication. As it is a passive form of authentication, the authentication will allow only the user with knowledge of the password, pass phrase, correct fingerprint, retina scan, and so on, to have access to the peripheral. This can prevent multiple users from using the peripheral. Although it is possible to share the passwords, the sharing of security information can significantly weaken the security of the peripheral. Additionally, the verification information (for example, passwords, pass phrases, and so forth) should be regularly changed to maintain integrity of the information, however, to share the updated password between a number of users can be difficult. Alternatively, while it is possible to record biometric information from multiple users, the recording of biometric information for multiple users can be time consuming. Furthermore, the need to continuously update the biometric information as authorized users change can make the maintenance of a list of authorized users difficult.

Another disadvantage of the prior art techniques is that the authentication requires interaction from the user, which can make the users less likely to make use of the available security features, especially if the authentication process is difficult or involved.

Yet another disadvantage of the prior art is that software and/or hardware may need to be installed on existing electronic devices. This can lead to incompatibility issues with the existing electronic devices. Furthermore, the software and hardware can increase the cost of the implementation of the security system as well as potentially decreasing the reliability of the electronic device, therefore potentially limiting its widespread use.

### SUMMARY OF THE INVENTION

These and other problems are generally solved or circumvented, and technical advantages are generally achieved, by preferred embodiments of the present invention which provides a peripheral and a method for seamlessly and actively securing and operating the peripheral.

In accordance with a preferred embodiment of the present invention, a method for securing a peripheral is provided. The method includes scanning a communications media for identifiers of devices using the communications media, and selecting identifiers from the scanned identifiers. The method also includes applying a combination function to the selected identifiers, and securing the peripheral based on an output of the applying.

In accordance with a preferred embodiment of the present invention, a method for operating a secured peripheral is provided. The method includes scanning a communications media for identifiers, and enabling access to a secured function of the peripheral in response to a determining that the scanned identifiers contain ail members of a list of selected identifiers.

In accordance with another preferred embodiment of the present invention, a peripheral is provided. The peripheral includes a radio frequency receiver for scanning a communications media for identifiers, a processing unit coupled to the radio frequency receiver and a functional unit, and a memory coupled to the radio frequency receiver and to the processing unit. The processing unit transparently provides access to a secured portion of the functional unit in response to a determining that the scanned identifiers contain all members of a list of selected identifiers, while the memory stores the list of selected identifiers and an application to secure the peripheral.

An advantage of a preferred embodiment of the present invention is that modifications to the electronic devices to which the peripherals are attached are not required. This can minimize the cost and maximize speed of implementing the present invention since no investment is needed to modify or otherwise change any hardware or software in the existing installed base of electronic devices. Furthermore, since modifications are not required, the reliability of the electronic devices is not affected.

A further advantage of a preferred embodiment of the present invention is that once the peripherals are secured, no additional investment of time or money is needed to maintain the security of the peripherals. For example, passwords do not need to be periodically updated and passed through to authorized users.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of a prior art technique for securing a peripheral;

FIG. 2 is a diagram of an exemplary system containing an electronic device and a peripheral;

FIG. 3 is a diagram of an exemplary system containing an electronic device and a peripheral, wherein the peripheral is a secured mass storage device, according to a preferred embodiment of the present invention;

FIGS. 4a through 4c are diagrams of sequences of events in the initialization and operation of a secured peripheral, according to a preferred embodiment of the present invention; and

FIGS. 5a through 5c are diagrams of an exemplary system containing an electronic device and a peripheral, wherein the peripheral is a communications peripheral, a data input peripheral, or a data output peripheral, according to a preferred embodiment of the present invention.

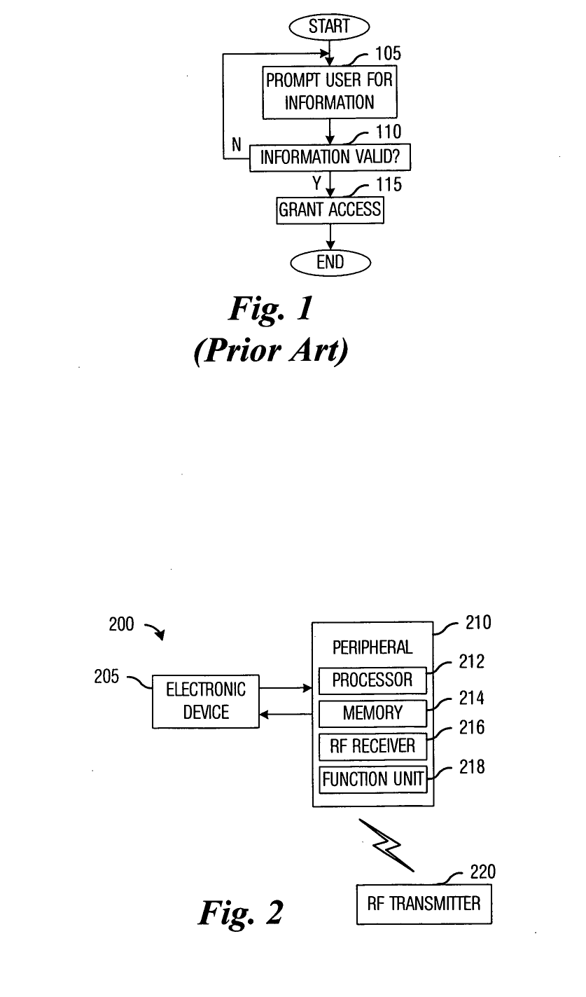

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a peripheral and a method for seamlessly and actively securing and operating the peripheral, such as a mass storage device. The invention may also be applied, however, to other applications wherein there is a need to secure access to electronic systems, such as computers, video and audio display systems, mechanical systems (for example, automobiles, trucks, industrial and production machinery, and so on), and so forth.

Active authentication can involve the recall and activation of specific program code that can be used to authenticate a user of an electronic device or system. Passive authentication, on the other hand, can simply utilize a comparison of unchanging authentication information against information stored in a secured location. The use of active authentication can allow the transfer of access to multiple users, while techniques using passive authentication, such as biometrics, cannot be transferred between multiple users. Furthermore, more elaborate authentication processes can be implemented using active authentication.

With reference now to FIG. 2, there is shown a diagram illustrating a system 200 containing an electronic device 205 and a peripheral 210. The peripheral 210 can be connected to the electronic device 205 to provide additional functionality and/or capabilities to the electronic device 205. For example, the peripheral 210 can provide data storage space, data input (for example, data capture) capabilities, data output (for example, display) capabilities, communications capabilities, and so forth. The use of peripherals can allow a user of the electronic device 205 to add desired capabilities to the electronic device 205 without having to purchase unwanted capabilities. Furthermore, peripherals can enable the expanding of the capabilities of the electronic device 205.

The peripheral 210 can attach to the electronic device 205 using a wired or a wireless connection. The wired connection can be an industry standard interface, such as USB, IEEE 1394, or a proprietary interface. Similarly, the wireless connection can use an industry standard interface or a proprietary interface. The wireless interface can make use of radio frequency (RF) signals, optical signals (either visible or invisible), sonic signals, microwave signals, or so on to communicate. In the system 200 shown in FIG. 2, the peripheral 200 is attached to the electronic device 205 via a wired interface.

The peripheral 210 can be secured to one or more users and/or locations to help prevent unauthorized access to the peripheral 210 should the peripheral 210 be stolen, for example. Depending on the implementation of the security system, unauthorized users can access some or none of the functionality of the peripheral 210. According to a preferred embodiment of the present invention, the security system of the peripheral 210 is active in nature. Furthermore, the security system of the peripheral 210 should be totally transparent to the electronic device 205, wherein the electronic device 205 should not require any modifications to either its hardware or software to secure the peripheral 210. Nor should the electronic device 205 even be aware that the peripheral 210 is or can be secured.

The peripheral 210 can include a processor 212 (or a controller, a custom designed integrated circuit, or so on), which can be responsible for controlling the operation of the peripheral 210 as well as executing any necessary code and applications needed to secure the operation of the peripheral 210. Also included in the peripheral 210 can be a memory 214 used to store data along with code and applications used in the securing of the peripheral, for example. A radio frequency (RF) receiver 216 can be used to scan specified radio frequency bands to look for RF identifiers used in the securing of the peripheral 210, which can be transmitted by one or more RF transmitters 220. Although shown utilizing RF signals, the peripheral 210 can readily be modified by those of ordinary skill in the art of the present invention to use other communications methods and techniques in securing the peripheral 210, such as light (both visible and non-visible), sound waves, and so forth.

The RF identifiers found by the RF receiver 216 can be used by the processor 212 to secure the functionality of the peripheral 210. The specific RF identifiers that are used in the securing process can be selected by the user or by an application executing in the processor 212. The selection of the RF identifiers and their use in the securing of the peripheral 210 are described in more detail below. Once the functionality of the peripheral 210 has been secured through the use of the selected RF identifiers, the functionality will not be accessible unless the same selected RF identifiers are present.

The peripheral 210 can also include a function unit 218, which is responsible for providing the functionality of the peripheral 210. For example, the function unit 218 may be a data storage device for a mass storage peripheral, a network interface unit for a networking peripheral, an optical sensor for a data input peripheral, a printer for a data output peripheral, and so forth.

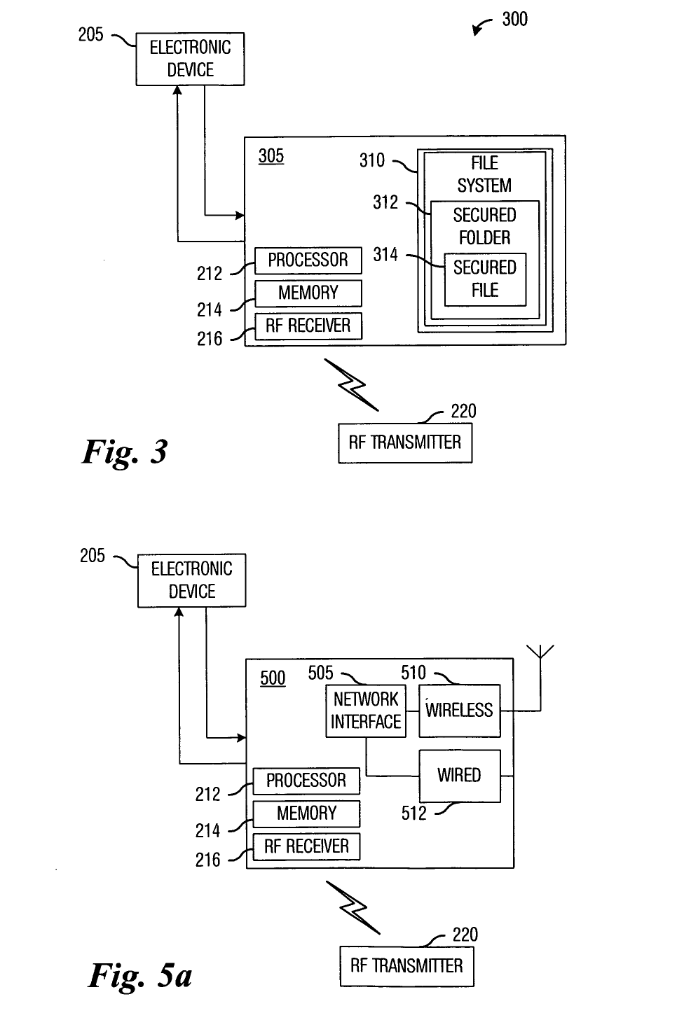

With reference now to FIG. 3, there is shown a diagram illustrating a system 300 with a secured mass storage peripheral 305, according to a preferred embodiment of the present invention. The secured mass storage peripheral 305 can be a portable disk drive, a flash memory drive, a data hologram, and so forth. The secured mass storage peripheral 305 may be connected to the electronic device 205 via a wired connection such as a USB compliant connection, an IEEE 1394 compliant connection, a proprietary connection, or some other form of wired connection. Alternatively, the secured mass storage peripheral 305 can be connected to the electronic device 205 via a wireless connection such as an IEEE 802.11 compliant connection, a BlueTooth compliant connection, a wireless USB compliant connection, a proprietary wireless connection, or some other form of wireless connection.

Like the peripheral 210 (FIG. 2), the secured mass storage peripheral 305 can include a processor 212, a memory 214, and an RF receiver 216. Additionally, the secured mass storage peripheral 305 can include a storage device 310, such as a hard disk drive, a flash memory drive, etc. The storage device 310 may have a file system that can include both a secured folder 312 and an unsecured folder (not shown). The secured folder 312 can include one or more secured files 314, which can comprise data and/or applications, as well as other secured folders. Files placed in the secured folder 312 can automatically be secured without needing specific interaction with the users of the electronic device 205 (other than placing the file in the secured folder 312) or the electronic device 205. The secured folder 312 can have several different access types, for example, access to a secured folder may be read only, write only, or read and write. The access type can be dependant on the user of the secured mass storage peripheral 305 and his/her access level. The unsecured folder can similarly contain one or more files that contains data and/or applications, as well as other folders.

The processor 212 can encrypt files stored in the secured folder 312 as they are being written to the storage device 310 as well as decrypt files as they are being read from the secured folder 312. According to a preferred embodiment of the present invention, the key (as generated by applying a logic function to the selected RF identifiers) can be applied to the files to encrypt and/or decrypt the files. Without the key generated from the selected RF identifiers, the secured folder 312 will not be visible to the electronic device 205, thereby preventing unauthorized access of any files stored in the secured folder 312.

According to a preferred embodiment of the present invention, the encryption and the decryption, along with other operations performed by the processor 212 of the secured mass storage peripheral 305, can occur without any intervention from the electronic device 205. To the electronic device 205, the secured mass storage peripheral 305 can have the appearance of an ordinary mass storage peripheral. The electronic device 205 will be able to access the unsecured folder of the secured mass storage peripheral 305 at all times and if the selected RF identifiers are present, the electronic device 205 will also be able to access the secured folder 312 of the secured mass storage peripheral 205 as well.

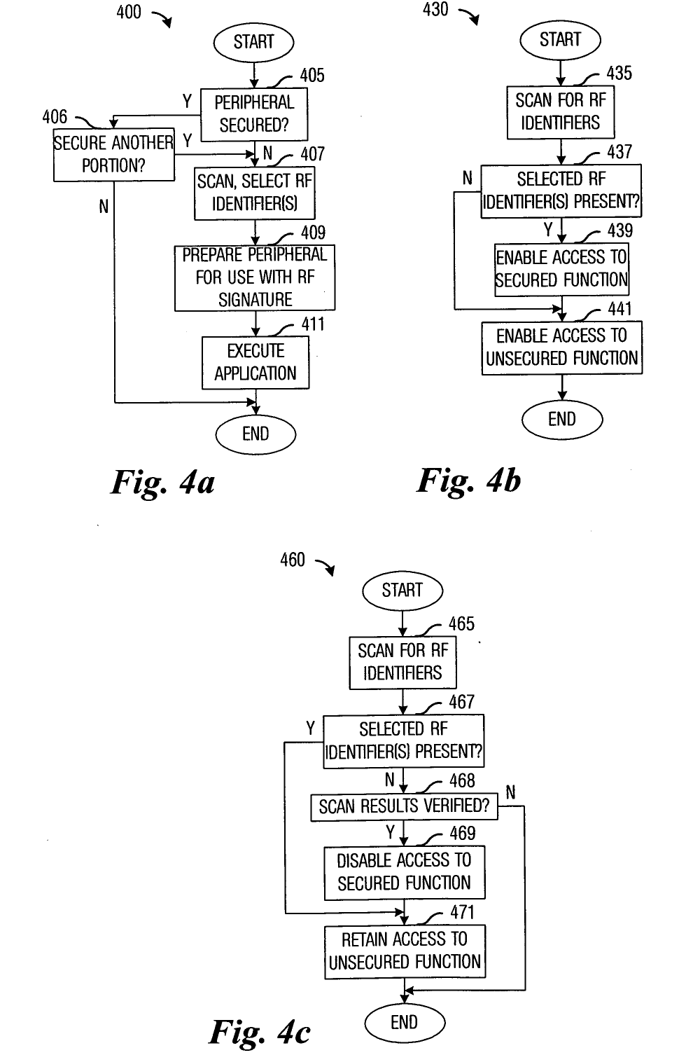

With reference now to FIGS. 4a through 4c, there are shown diagrams illustrating sequences of events in the initialization and operation of a secured peripheral, according to a preferred embodiment of the present invention. The discussion of the initialization and operation of the secured peripheral will utilize a secured mass storage peripheral 305. However, the initialization and operation of other types of secured peripherals can be substantially similar, therefore, the discussions provided herein should not be construed as being limiting to the scope or the spirit of the present invention.

The diagram illustrated in FIG. 4a illustrates a sequence of events 400 in the initialization of a secured mass storage peripheral 305. The initialization can occur during an initial power up of the secured mass storage peripheral 305, wherein the secured mass storage peripheral 305 is automatically placed in an initialization mode. Alternatively, the initialization can occur when a previously unsecured secured mass storage peripheral 305 can be intentionally placed in the initialization mode through the setting of some switches, executing an initialization program, entering a specific sequence, powering the secured mass storage peripheral 305 up in a special RF environment, and so forth.

The initialization of the secured mass storage peripheral 305 can begin with a check to determine if the secured mass storage peripheral 305 is currently secured (block 405). For example, in a secured mass storage peripheral 305, the peripheral can be determined to be currently secured if there is already a secured folder 312 (FIG. 3) present in the secured mass storage peripheral 305. Such a determination may be necessary if the secured mass storage peripheral 305 supports different secured folders 312 for different users (or groups of users) (block 407). If the secured mass storage peripheral 305 has not been previously secured or if the secured mass storage peripheral provides support for securing multiple portions of the storage device 310 (block 406), then the initialization can proceed to secure a portion of the storage device 310. Alternatively, the secured mass storage peripheral 305 can be secured if a memory storage location is set to a specified value.

The securing of a portion of the storage device 310 can begin with a scanning of specified RF frequency bands to detect available RF identifiers (block 407). Examples of RF frequency bands can be frequency bands used by RFID devices, wireless networks, and so forth. The scanning for RF identifiers can find RF identifiers associated with employee badges, MAC addresses of wireless devices, network identifiers of wireless networks, and so on. After detecting the available RF identifiers, the user can be prompted to select RF identifiers that can be used to grant access to the secured folder 312. For example, the user can select his own badge's RF identifier, a network identifier of his wireless local area network, a technical support user's badge RF identifier, and so forth. The list of selected RF identifiers can be saved in a memory, such as the memory 214 (FIG. 2), for later use. According to a preferred embodiment of the present invention, the list of selected RF identifiers can be encrypted for security reasons.

Alternatively, the initiation process can be configured to automatically select the strongest RF identifiers that have been detected. In another preferred embodiment of the present invention, the initialization process can select the strongest RF identifier of each different type of RF identifier. For example, the initialization process can select the strongest badge RF identifier, the strongest network identifier, and so forth. The automatic selection of RF identifiers can be useful in applications wherein the secured peripheral has limited (or no) user interface capabilities.

In yet another alternate preferred embodiment, the scan for RF identifiers can look for the absence of a particular RF identifier or signal, the absence of which may be required to enable the securing of a portion of the mass storage peripheral. An example of a use for such an embodiment can involve the use of a jamming type of signal that can be provided over an operating area to prevent the use of secured devices in a military installation to help prevent illicit removal of vital information.

In yet another alternate preferred embodiment, the scan for RF identifiers can look for the presence of RF identifiers appearing in a specified sequence, order, or pattern. For example, in order to secure the secured mass storage peripheral 305, the user may be required to carry the secured mass storage peripheral 305 through a specific sequence of access points (wireless network devices) and/or stationary/mobile sources of RF identifiers. As the user carries the secured mass storage peripheral 305 through the specified path (trajectory) and encounters the sources of RF identifiers, such as network devices, people (with RF badges), and so forth, the secured mass storage peripheral 305 will detect the RF identifiers as they come into range. The order that the RF identifiers are detected, as well as the RF identifiers, can be used in the securing process. An advantage of this technique is that it can prevent the external monitoring of RF signals around a physical location to steal RF identifiers to compromise the security of the secured mass storage peripheral 305.

After selecting the RF identifiers, the initialization process can then prepare the secured mass storage peripheral 305 for use using the selected RF identifiers (block 409). The preparation can include the storage of the selected RF identifiers along with other necessary information in a memory. Depending on the implementation of the secured mass storage peripheral 305, the list of selected RF identifiers can be stored in a memory for subsequent use. The memory can be a write-one read-many memory if the secured mass storage peripheral 305 is designed to be assigned to a single user. Alternatively, the memory can be erasable if the secured mass storage peripheral 305 is designed so that it can be used in many different environments or by many different users. If the memory is erasable, the secured mass storage peripheral 305 should be configured so that the memory cannot be erased unless the secured mass storage peripheral 305 has been placed in a special operating mode, such as initialization or configuration. The special operating mode may also require that the secured mass storage peripheral 305 be turned on in the presence of the RF environment stored in the memory and then a special application be executed (or a pass phrase, password, pass sequence, biometric data, or so forth, be entered), for example.

The initialization process can then complete with the execution of an application that locks the secured mass storage peripheral 305 using the selected RF identifiers (block 411). With the secured mass storage peripheral 305, for example, the application can perform a surface write to the storage device 310. The surface write can be a formatting of a portion of the storage device 310 that corresponds to the secured folder 312. The surface write can include the writing of a logical combination of the selected RF identifiers onto the surface of the storage device 310. The portion of the storage device 310 corresponding to the secured folder 312 can now have the appearance of random bits when not enabled. However, when the secured folder 312 is enabled with a logical combination of the selected RF identifiers, an electronic device will see a folder in the storage device 312 that is suitable for storing data and/or applications. A discussion of the normal operation of the secured mass storage peripheral-305 and the enabling of the secured folder 312 is provided below.

The logical combination can be a way to combine the selected RF identifiers to specify how access is to be granted to the secured mass storage peripheral 305. The selected RF identifiers can be grouped so that all of the selected RF identifiers must be present to enable access to the secured mass storage peripheral 305. This can be achieved using a logical AND of all the selected RF identifiers. Alternatively, the selected RF identifiers can be grouped so that any of the selected RF identifiers can be present to enable access to the secured mass storage peripheral. This is a logical OR of all the selected RF identifiers. It can also be possible to group the selected RF identifiers so that certain combinations of the selected RF identifiers must be present. This is a logical AND and a logical OR of all the selected RF identifiers.

For example, if there are five selected RF identifiers (RF_1 through RF_5), the logical combination that requires all five selected RF identifiers to enable access to the secured mass storage peripheral 305 can be expressed as RF_1 AND RF_2 AND RF_3 AND RF_4 AND RF_5. A logical combination that will enable access to the secured mass storage peripheral 305 with any of the five selected RF identifiers can be expressed as RF_1 OR RF_2 OR RF_3 OR RF_4 OR RF_5. A logical combination that will enable access to the secured mass storage peripheral 305 if the first three selected RF identifiers or the last three selected RF identifiers or the second and the fourth selected RF identifiers are present can be expressed as (RF_1 AND RF_2 AND RF_3) OR (RF_3 AND RF_4 AND RF_5) OR (RF_2 AND RF_4). The actual logical combination of the selected RF identifiers depends upon the desired security and is beyond the scope of the present invention and will not be discussed herein.

In addition to a logical combination of the RF identifiers, it is also possible to combine the RF identifiers in a sequential or ordered manner. For example, a sequential combination of RF identifiers may require that a first RF identifier by detected, followed by a second RF identifier and then a third RF identifier. The sequential combination can be expressed as RF_1 THEN RF_2 THEN RF_3. The sequential combination of RF identifiers can be used to implement the movement of the secured mass storage peripheral 305 through a specified trajectory. According to a preferred embodiment of the present invention, the sequential combination of the RF identifiers will be mutually exclusive at any given point in time. Furthermore, it can be possible to combine logical and sequential combinations of RF identifiers. For example, a combination expressed as (RF_1 AND RF_2) THEN RF_3 THEN (RF_4 OR RF_5) can require that a first RF identifier and a second RF identifier be simultaneously present, followed by a third RF identifier, and then either a fourth RF identifier or a fifth RF identifier.

The writing of the logical combination (and/or the sequential combination) of the selected RF identifiers onto the surface of the storage device 310 can result in the area corresponding to the secured folder 312 having the appearance of an unformatted storage area when the selected RF identifiers are not present. However, when the selected RF identifiers are present, the area corresponding to the secured folder 312 will appear to be a storage area that is ready to store data and/or applications. According to a preferred embodiment of the present invention, the secured mass storage peripheral 305 can prevent the area corresponding to the secured folder 312 from being accidentally or purposefully formatted, erased, or otherwise damaged.

The initialization process of a secured mass storage peripheral can depend on the capabilities of the user interface available on the secured mass storage peripheral. For example, for secured mass storage peripherals that are directly connected to an electronic device and can make use of the user interface of the electronic device, a feature rich initialization process can be available, such as the initialization process described above. If the secured mass storage peripheral has a limited user interface or cannot make use of the user interface of the electronic device, a more limited initialization process may be required.

An example of a limited initialization process can be a hardware based initialization process that requires the user to enter a sequence using buttons (or switches, touch pad, or so forth) on the secured mass storage peripheral, hold down a set of buttons, set a jumper or switch, and so forth, and then power on the secured mass storage peripheral. Upon power up, the secured mass storage peripheral can begin the initialization process, where it can automatically select a number of the strongest detectable RF identifiers, the strongest detectable RF identifier for each type of RF identifier, or so on.

In a secured mass storage peripheral with no user interface and no ability to utilize the user interface of the electronic device, the initialization process may be set to execute on the first (or some other fixed number) power up of the secured mass storage device. Alternatively, the initialization process may be set to execute on the detection of a particular RF identifier or set of RF identifiers and if the secured mass storage peripheral has not already been secured, which can allow the initialization process to occur when the secured device is powered on at a designated location. The particular RF identifier can be programmed during manufacture of the secured mass storage peripheral or by a trusted entity, such as a distributor of the secured mass storage peripheral, for example.

The diagram shown in FIG. 4b illustrates a sequence of events 430 in the normal operation of the secured mass storage peripheral 305. The sequence of events can be descriptive of events occurring in the normal operation of the secured mass storage peripheral 305, which can occur after the secured mass storage peripheral 305 has been initialized, such as shown in FIG. 4a. Once initialized, the secured mass storage peripheral can operate in a normal operating mode whenever it is powered on and connected to an electronic device 205.

The normal operating mode of the secured mass storage peripheral 305 can begin with a scan of specified RF frequency bands to detect RF identifiers (block 435). According to a preferred embodiment of the present invention, the scanning of the specified RF frequency bands can be performed by the RF receiver 216 located in the secured mass storage peripheral 305. After scanning the specified RF frequency bands, any detected RF identifiers can be compared to a list of selected RF identifiers, such as the list of selected RF identifiers created during the initialization of the secured mass storage peripheral 305 (block 437).

If the selected RF identifiers are all present, then access to the secured folder 312 of the secured mass storage peripheral 305 can be enabled (block 439). Also, access to the unsecured folder of the secured mass storage peripheral 305 is granted (block 441). According to a preferred embodiment of the present invention, the enabling can involve the computation of a logical and/or sequential combination of the selected RF identifiers, which can then be used to enable access to the secured folder 312. For example, the logical and/or sequential combination of the selected RF identifiers can be used to convert encoded portions of the storage device 310 so that the electronic device 205 can recognize the secured folder 312. Typically, the conversion can be performed on the fly. The conversion should be performed by the processor 212 and making use of the memory 214 and not be written back to the storage device 310 so that the security of the information in the secured folder 312 is not compromised. Without the logical combination of the correct RF identifiers, the conversion of the secured folder 312 can still have the appearance of random noise. Even if all of the selected RF identifiers are not present, thereby not enabling access to the secured folder 312, access to the unsecured folder can be enabled (block 441).

The diagram shown in FIG. 4c illustrates a sequence of events 460 in the verification of the presence of the selected RF identifiers. Since an RF environment can be dynamic in nature, with RF signals appearing and disappearing over time, it can be necessary to periodically scan the specified RF frequency bands to ensure that the selected RF identifiers remain present in the RF environment of the secured mass storage device 305. For example, the detection of the RF identifier associated with a user's badge could have enabled access to the secured mass storage peripheral 305, however, if the user walks away from the immediate area of the secured mass storage peripheral 305, access to the secured mass storage peripheral 305 should be rescinded. Additionally, if the presence of an RF identifier can prevent access to the secured mass storage peripheral 305, then the scan for RF identifiers should be performed regularly to ensure that the presence of such RF identifiers are detected.

According to a preferred embodiment of the present invention, the scan of the specified RF frequency bands can occur periodically (block 465), with the frequency of the scan being dependent on factors such as: desired security for the secured mass storage peripheral 305 (with greater security requiring more frequent scans), available processing power to process the results of the scans, the need to utilize the RF receiver for other functions, and so on, as shown in FIG. 4c. Once the scan completes, a check can be made to determine if the selected RF identifiers used to enable access to the secured mass storage peripheral are present (or missing, depending on the nature of the selected RF identifiers) (block 467). If not all of the selected RF identifiers are present (or in the case of jamming RF identifiers, if one or more of the selected RF identifiers are present), then access to the secured mass storage peripheral 305 can be disabled (block 469). However, access to any unsecured portion of the mass storage peripheral 305 will remain enabled (block 471).

According to a preferred embodiment of the present invention, since the RF environment can continually change, a verification scan (or scans) can be utilized to help ensure that the absence (or presence) of some of the selected RF identifiers as detected by the scan of block 465 was not a transient event (block 468). The verification scan should take place prior to disabling access to the secured mass storage peripheral 305. The verification scan can help to reduce the effects of RF signal fades, where an RF signal can temporarily fade-out and then reappear.

The verification scan(s) can occur immediately or at a specified time after the occurrence of the scan in block 365. An immediate verification scan can help to increase the security of the secured peripheral, while a verification scan occurring some time after the scan of block 365 can help to reduce the frequency of erroneously disabling the secured portions or functions of the secured peripheral due to signal fading.

In addition to the secured mass storage device, there can be three other general classifications of secured peripherals that can be used with an electronic device, such as a computer. The three additional classes can be: 1) communications peripheral, 2) data capture peripheral, and 3) data display peripheral. Examples of a communications peripheral can be a modem or a network adapter, while exemplary data capture peripherals can include a keyboard, a mouse, a scanner, a thermal sensor, a digital camera, and so forth. Data display peripherals can encompass devices such as a display monitor, a printer, an audio speaker or headset, and so on.

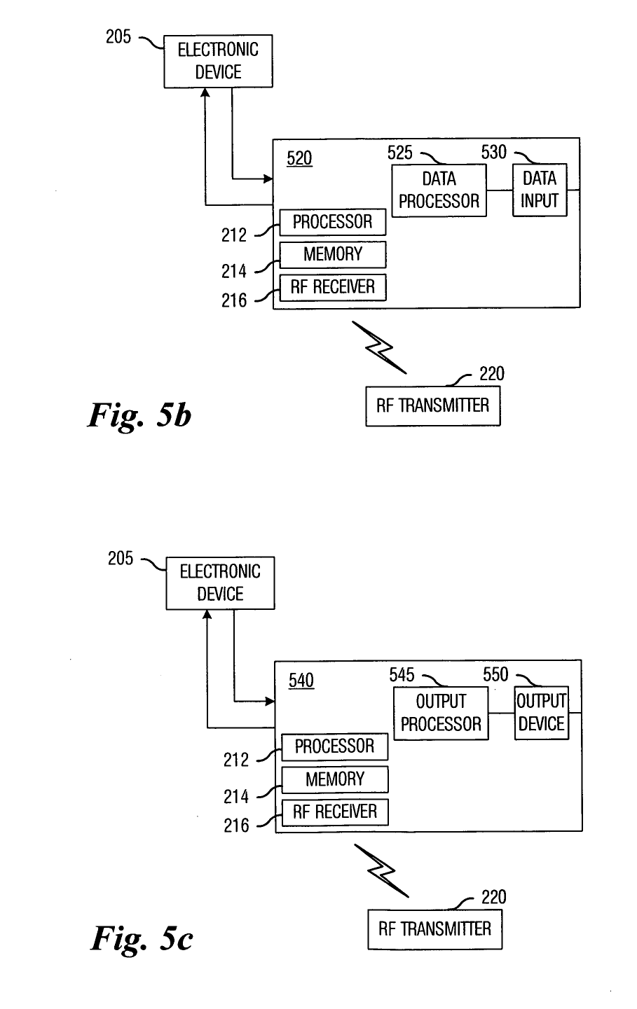

With reference now to FIGS. 5a through 5c, there are shown diagrams illustrating exemplary systems with secured versions of each class of peripheral, according to a preferred embodiment of the present invention. The diagram shown in FIG. 5a illustrates an exemplary system with a secured communications peripheral 500. An example of a secured communications peripheral can be a wired or wireless network adapter or a wired or wireless modem. The secured communications peripheral 500 can include a processor 212, a memory 214, and an RF receiver 216 like the secured mass storage device 305 (FIG. 3), since they are necessary to support the detection of RF identifiers and securing access to the secured communications peripheral 500. The secured communications peripheral 500 can also include a network interface 505 (sometimes referred to as a media access control controller (MAC controller)), which can function as a bridge between the electronic device 505 and a network that is connected to the electronic device 205, translating communications commands and data into a format that is compatible with its intended recipient.

Depending on the type of network connection (wired or wireless), the secured communications peripheral 500 can include a wireless interface 510 that can contain an RF transceiver or a wired interface 512 or both. Although shown in FIG. 5a as being an RF wireless interface, the wireless interface 510 can utilize other forms of wireless communications, such as optical, non-optical, ultrasonic, microwave, and so forth.

The secured communications peripheral 500 can limit a user's access to external networks. For example, based on the user's access level, the user may be granted access only to a subset of a company's network, all of the company's network, a filtered version of the Internet, all of the Internet, and so forth.

The diagram shown in FIG. 5b illustrates an exemplary system with a secured data input peripheral 520. Examples of a secured data input peripheral can be a keyboard, a mouse, a scanner, a digital camera, and so forth. Like the secured communications peripheral 500 or the secured mass storage device 305, the secured data input peripheral 520 can include a processor 212, a memory 214, and an RF receiver 216, which are necessary to support the detection of RF identifiers and securing access to the secured data input peripheral 520. The secured data input terminal 520 can also include a data processor 525, which can process data being provided by a data input 530. The data input can be an image sensor, a positional sensor, and so forth.

The diagram shown in FIG. 5c illustrates an exemplary system with a secured data output peripheral 540. Examples of a secured data output peripheral a computer display, a printer, a multimedia device, and so on. The secured data output peripheral 540 can include a processor 212, a memory 214, and an RF receiver 216, which are necessary to support the detection of RF identifiers and securing access to the secured data output peripheral 540. The secured data output peripheral 540 can also include an output processor 545, which can be responsible for performing tasks such as encoding/decoding data into a format compatible with an output device 550. For example, the output processor 545 can decode an MP3 encoded sound file into audio signals that can be output via speakers or encode a graphics file into a printer description language for printing purposes.

The secured data input peripheral 520 and the secured data output peripheral 540 can be used to control a user's access to inputting and outputting data. For example, the secured data input peripheral 520 can block a user's ability to use a scanner or a digital camera but still allow the user to make use of a keyboard and mouse, while the secured data output peripheral 540 can allow a user to view a data file on a display, but can prevent the user from printing the data file.

The initialization and operation of the secured peripherals shown in FIGS. 5a through 5c can be substantially similar to the initialization and operation of the secured mass storage device 305 shown in FIGS. 4a through 4c. Differences may arise from varying user interface capability. For example, a secured digital camera or a secured network interface peripheral may not have the same user interface capability as the secured mass storage peripheral 305 that is coupled to a computer and is making use of the computer's user interface.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for securing a peripheral, the method comprising:
scanning a communications media for identifiers of devices utilizing the communications media;
selecting identifiers from the scanned identifiers;
applying a combination function to the selected identifiers; and
securing the peripheral based on an output of the applying.

2. The method of claim 1 further comprising, prior to the scanning, determining that the peripheral is to be secured.

3. The method of claim 2, wherein the determining comprises powering on the peripheral for the first time.

4. The method of claim 2, wherein the determining comprises:
powering on the peripheral;
scanning the communications media for identifiers of devices utilizing the communications media; and
detecting a specified identifier.

5. The method of claim 4, wherein the detecting comprises detecting an absence of the specified identifier.

6. The method of claim 1, wherein the scanning comprises scanning one or more radio frequency bands for radio frequency identifiers.

7. The method of claim 6, wherein the scanning occurs as the peripheral is moved along a specified path.

8. The method of claim 1, wherein the selecting comprises a user of the peripheral manually selecting the scanned identifiers.

9. The method of claim 1, wherein the selecting comprises an automatic selecting of the scanned identifiers.

10. The method of claim 1, wherein the combination function comprises logical functions.

11. The method of claim 10, wherein the combination function comprises sequential functions.

12. The method of claim 1, wherein the securing comprises:
providing the output of the applying to a functional unit of the peripheral; and
locking the functional unit with the output.

13. The method of claim 1, wherein the peripheral comprises a mass storage device, and wherein the securing comprises writing the output of the applying to a portion of a surface of the mass storage device, with the portion corresponding to a secured portion of the mass storage device.

14. A method for operating a secured peripheral, the method comprising:
scanning a communications media for identifiers; and
enabling access to a secured function of the peripheral in response to a determining that the scanned identifiers contain all members of a list of selected identifiers.

15. The method of claim 14 further comprising, after the enabling, enabling access to an unsecured function of the peripheral.

16. The method of claim 14 further comprising, after the enabling of access to the secured function:
periodically scanning the communications media for identifiers; and
disabling access to the secured function of the peripheral in response to a determining that the scanned identifiers do not contain all members of the list of selected identifiers.

17. The method of claim 16 further comprising, prior to disabling access to the secured function, verifying the determining that the scanned identifiers do not contain all members of the list of selected identifiers.

18. The method of claim 17, wherein the verifying comprises:
repeating a scan of the communications media for identifiers; and
determining that the scanned identifiers do not contain all members of the list of selected identifiers.

19. A peripheral comprising:
a radio frequency receiver for scanning a communications media for identifiers;
a processing unit coupled to the radio frequency receiver and a functional unit, the processing unit configured to transparently provide access to a secured portion of the functional unit in response to a determining that the scanned identifiers contain all members of a list of selected identifiers; and
a memory coupled to the radio frequency receiver and to the processing unit, the memory to store the list of selected identifiers and an application to secure the peripheral.

20. The peripheral of claim 19, wherein the functional unit comprises a mass storage device, wherein the mass storage device is partitioned into a secured part that is accessible only when enabled by the processing unit and an unsecured part that is always accessible.
